(19) United States
(12) Patent Application Publication
(10) Pub. No.: US 2002/0154975 A1
(43) Pub. Date: Oct. 24, 2002

(54) Method and apparatus for wafer exchange employing stacked robot blades

(75) Inventors: Ilya Perlov, San Francisco, CA (US); Gregory Tsybulsky, Campbell, CA (US); Alexey Goder, Sunnyvale, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/838,414

(22) Filed: Apr. 18, 2001

(51) Int. Cl. B65G 49/07

(52) U.S. Cl. 414/416.03

(57) ABSTRACT

A wafer to be processed is loaded into a processing chamber in the same operation in which a processed wafer is unloaded from the processing chamber. As part of this operation, a set of lift pins lifts the processed wafer from a processing platform. A set of storage pins is extended above the lifted wafer and defines an upper wafer transfer position. A robot arm having a stacked set of wafer handling blades is inserted into the processing chamber with a wafer to be processed on the upper blade. The storage pins may lift the wafer to be processed off the upper blade at the same time that the lift pins lower the processed wafer onto the lower blade of the robot arm. The robot arm retracts, withdrawing the processed wafer from the processing chamber. The wafer to be processed may be lowered to the processing platform by the storage pins.

### FIELD OF THE INVENTION

The present invention relates to semiconductor manufacturing of thin substrates or wafers and, more particularly, to the transfer and loading of semiconductor wafers, glass plates and the like into and out of processing chambers.

### BACKGROUND OF THE INVENTION

Semiconductor manufacturing generally requires that a number of different processes be applied to a substrate such as a wafer. Typically, each process is applied to a wafer in a different chamber dedicated to a respective process. Thus the manufacturing process involves not only a sequence of processes carried out in the respective chambers, but also transporting wafers among the processing chambers, and loading and unloading wafers into and out of the processing chambers. Most modern semiconductor processing is carried out in chambers configured to process one wafer at a time, in a very high vacuum capable environment. Thus, a process to be performed in a particular chamber cannot be carried out while wafers are being loaded into or removed from the processing chamber. Consequently, reducing the time required to load and unload wafers into and out of processing chambers is a significant factor in maximizing manufacturing throughput.

It is therefore desirable to provide for rapid and reliable transfer of wafers to and from processing chambers.

### SUMMARY OF THE INVENTION

According to a first aspect of the invention, a wafer transfer apparatus includes a platform to and from which a wafer is to be transferred. The wafer transfer apparatus further includes a first mechanism adapted to selectively define a first wafer transfer position above the platform and a first plurality of pins selectively extendable from the platform and adapted to selectively define a second wafer transfer position above the first wafer transfer position. The wafer transfer apparatus further includes a pair of transfer blades movable in unison with each other relative to the wafer transfer positions and adapted to simultaneously receive a first wafer from the first wafer transfer position and deliver a second wafer at the second wafer transfer position.

According to a second aspect of the invention, a method of transferring wafers to and from a platform includes lifting a first wafer from the platform, extending a first plurality of pins from the platform, and lowering the first wafer onto a first wafer handler blade while substantially simultaneously transferring a second wafer from a second wafer handler blade to the first plurality of pins (e.g., by raising the first plurality of pins and/or by lowering the wafer handler blade).

According to a third aspect of the invention, a method of transferring wafers to and from a platform includes the following steps: raising a first plurality of pins to lift a first wafer from the platform; raising a second plurality of pins; using the first plurality of pins to place the first wafer on a first wafer handler blade; using the second plurality of pins to lift the second wafer from a second wafer handler blade; retracting the first plurality of pins; and using the second plurality of pins to lower the second wafer to the platform.

The methods and apparatus of the present invention allow wafer exchange with respect to a processing chamber to be carried out with a high degree of efficiency. Loading of a new wafer into the processing chamber and removal of a processed wafer from the processing chamber may be carried out in a single operation which requires only one insertion of a wafer handler into the processing chamber. Furthermore, processes for placing the processed wafer on a wafer handler blade and removing a new wafer to be processed from another wafer handler blade are overlapped, thereby minimizing loading and unloading time. Moreover, the methods and apparatus of the present invention may call for a relatively simple wafer handling mechanism, which can be produced at low cost.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a schematic side elevational view of a wafer transfer system provided in accordance with the invention;

FIG. 2 is a schematic side elevational view of a storage pin which is part of the system of FIG. 1; and

FIGS. 3A-3H are schematic rear elevational views that illustrate a sequence of stages in a wafer transfer operation carried out in accordance with the invention.

### DETAILED DESCRIPTION OF PREFERRED EMBODIMENTS

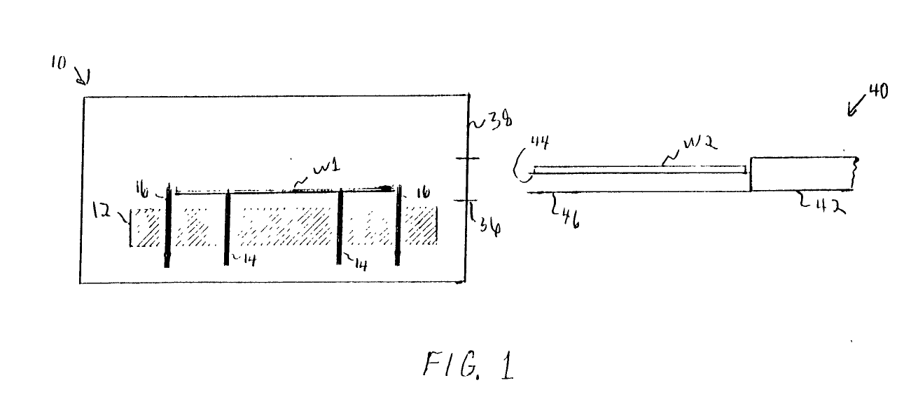

FIG. 1 is a schematic side elevational view of a wafer transfer system provided in accordance with the invention.

Reference numeral 10 indicates a processing chamber into which wafers are loaded and from which wafers are unloaded. The processing chamber 10 may be any type of chamber used to process a wafer in connection with a manufacturing process. For example, the processing chamber 10 may be a deposition chamber (including a chemical vapor deposition chamber or a physical vapor deposition chamber), an etching chamber, a photolithography chamber, a loadlock chamber, a degassing chamber, a heating chamber or a cooling chamber. The processing chamber 10 includes a platform 12 on which a wafer rests during processing.

Conventional lift pins 14 are selectively extendable from the platform 12 to lift wafers from the platform 12. A wafer W1 is shown supported at a position above the platform on the lift pins 14. Although only two lift pins 14 are shown in the drawing, it will be understood that the number of lift pins may be, for example, three or four, so as to provide stable support for a wafer.

Also selectively extendable from the platform 12 are storage pins 16.

FIG. 2 shows details of a typical one of the storage pins 16. As best seen in FIG. 2, the storage pin 16 has a wafer support portion 18 that extends horizontally and inwardly from an upper end 20 of the pin 16. The storage pin 16 is mounted at its lower end to a bearing 22. The bearing 22 permits the storage pin 16 to pivot between a substantially vertical position shown in solid lines in FIG. 2 and a pivoted position shown in dashed lines at 24. Arrow mark 26 is indicative of the pivoting motion of the storage pin 16. The pivoted position 24 is exaggerated for purposes of illustration in FIG. 2, and preferably diverges by only about one degree from the vertical. This small amount of pivoting is sufficient to cause the horizontally extending wafer support portion 18 to be clear of a locus at which a wafer may be positioned on or above the platform 12 when positioned relative to a wafer as shown in FIG. 2.

A pneumatic cylinder 28 is coupled to the storage pin 16 to provide a motive force for pivoting movement of the storage pin 16. A first and second motion stop S may be positioned so as to stop the motion of the storage pin 16 at the desired substantially vertical position and pivoted position, respectively. The bearing 22 is mounted on a lift platform 30 which is movable up and down, as indicated by arrow mark 32, by means of a motor 34. The up and down movement of the lift platform serves to extend and retract the lift pin 16.

As in the case of the lift pins 14, only two storage pins 16 are shown in FIG. 1, but the actual number of storage pins 16 may be three, four or more, so as to provide stable support for a wafer. Alternatively, pins could include an arcuate segment sufficient for only two pins to support a wafer.

Referring once more to FIG. 1, the processing chamber 10 has a slit valve 36 positioned in a front wall 38 of the processing chamber. The slit valve 36 can be selectively opened to allow wafers to be loaded into and unloaded from the processing chamber 10. Shown positioned adjacent the slit valve 36 is a wafer handler 40. The wafer handler 40 includes a robot arm 42, to which vertically stacked wafer handling blades 44 and 46 are fixedly mounted. (The wafer handling blades are also sometimes referred to as “transfer blades” or simply “blades”.) A wafer W2, to be processed in the processing chamber 10, is shown carried on the upper wafer handling blade 44. As used herein “blade” refers to any end effector capable of transferring a wafer to/from the lift mechanism (e.g., to/from lift pins 14) and to/from the storage pins 16. Accordingly “blade” is not to be limited to end effectors having a specific blade shape.

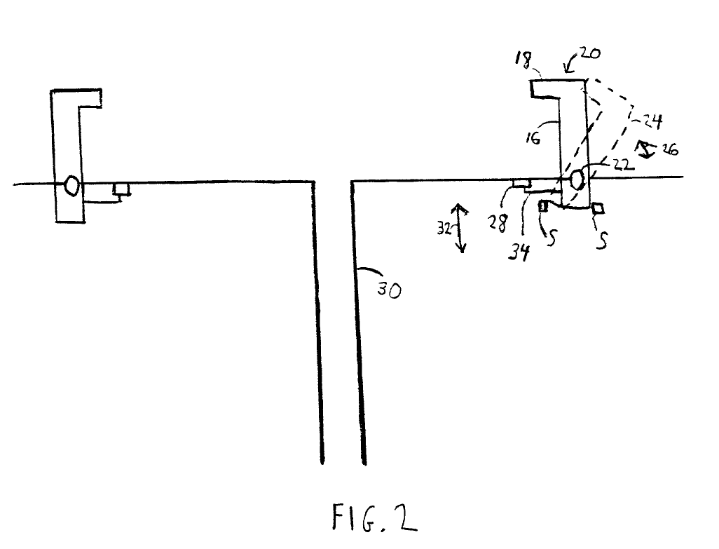

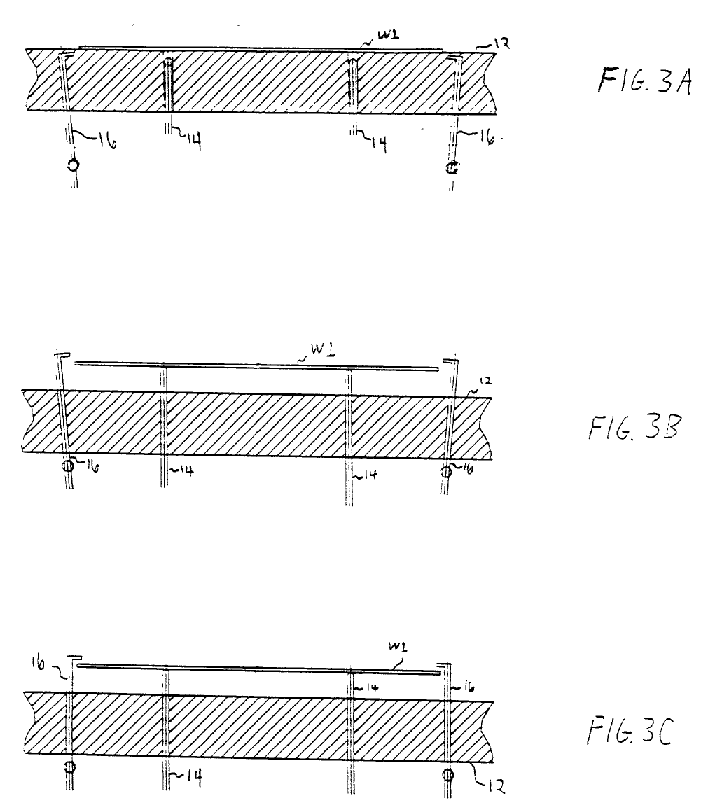

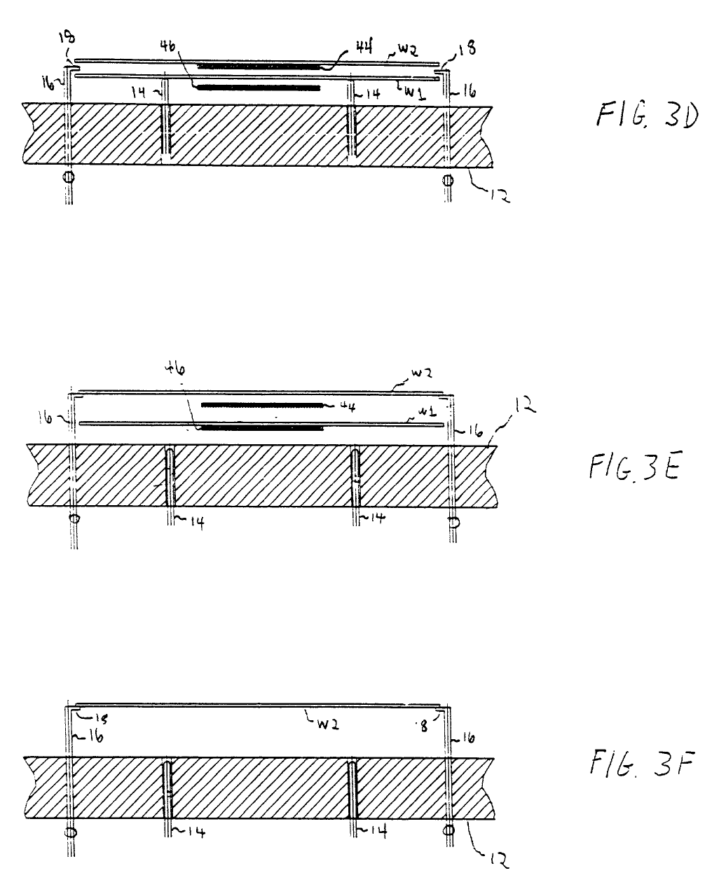

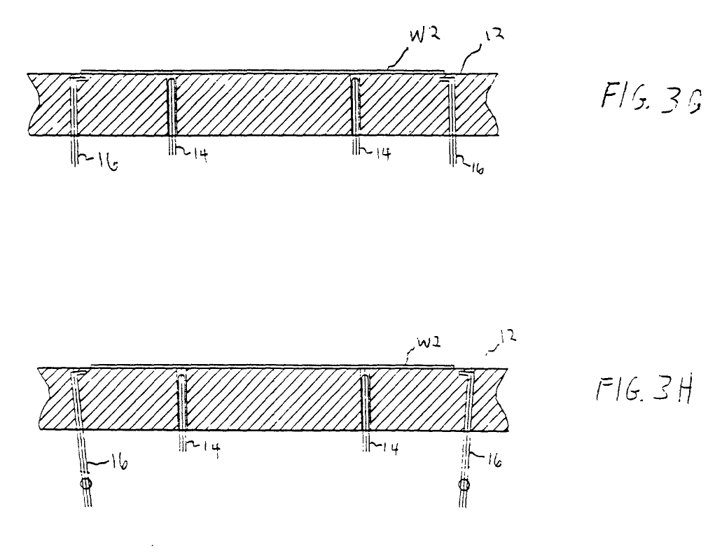

Operation of the wafer transfer system of the present invention to exchange a wafer to be processed with a wafer that has already been processed will now be described with reference to FIGS. 3A-3H.

FIG. 3A illustrates a condition that is in effect in the processing chamber at a time when processing of a wafer W1 has been completed. It will be observed that the wafer W1 is resting on the platform 12. Lift pins 14 are in a retracted condition such that the pins 14 do not extend above the surface of the platform 12. Storage pins 16 are also in a retracted condition, and further are pivoted outwardly (like the position 24 of FIG. 2).

Since processing of the wafer W1 is complete, a wafer exchange operation is initiated. First, the storage pins 16 are raised while maintaining the storage pins 16 in the outwardly pivoted position. At the same time, lift pins 14 are raised to lift the wafer W1 off the surface of the platform 12. The result of the raising of the pins 14 and 16 is illustrated in FIG. 3B. It will be observed that the upper ends of the storage pins 16 are raised to a position that is higher than the wafer W1. The storage pins 16 are able to pass by the wafer W1 by virtue of being in an outwardly pivoted position at the time that the pins 16 are raised, and by having stems that are located outward of the locus of pins 14.

Next, the storage pins 16 are pivoted into their upright position (FIG. 3C) so as to define a wafer transfer and storage position above the position of wafer W1.

The slit valve 36 (FIG. 1) is opened, and the robot arm 42 is extended so that wafer handling blades 44 and 46 are inserted into the processing chamber 10 to produce a condition that is illustrated in FIG. 3D. The upper wafer handling blade 44 carries a wafer W2 which is to be processed in the processing chamber. The robot arm 42 is positioned at a height such that the wafer W2 is inserted into the processing chamber 10 at a height that is a short distance above the position defined by the storage pins 16, and such that the lower wafer handling blade 46 is inserted a short distance below the processed wafer W1 which is supported on the lift pins 14.

At this point, the storage pins 16 are raised a short distance to lift the wafer W2 from the upper wafer handling blade 44. Substantially simultaneously, the lift pins 14 are lowered (retracted) to place the processed wafer W1 on the lower wafer handling blade 46. The result of these operations is illustrated in FIG. 3E. As a consequence of these operations, the wafer to be processed has been picked up from the wafer handler at substantially the same time that the processed wafer is placed on the wafer handler for removal from the processing chamber.

At this time the robot arm 42 is retracted to withdraw the wafer handling blades 44 and 46 from the processing chamber and the slit valve 36 is closed. The withdrawal of the wafer handling blades also unloads the processed wafer W1 from the processing chamber, since the wafer W1 is carried on the lower wafer handling blade 46. The condition in the processing chamber after withdrawal of the wafer handling blades is illustrated in FIG. 3F. It will be observed that the wafer W2, which is to be processed, is supported on the wafer support portions 18 of the storage pins 16. Also, the lift pins 14 have been retracted such that the pins 14 are flush with or below the surface of the platform 12.

The storage pins 16 are then retracted to lower the wafer W2 to the surface of the platform 12. In this example, the lift pins 14 remain retracted, and therefore do not interfere with the lowering of the wafer W2. The wafer W2 is now in place on the platform 12 for processing in the processing chamber (FIG. 3G). Before, during or after processing of the wafer W2, the storage pins 16 are pivoted outwardly (to the position 24 shown in FIG. 2), to produce the condition illustrated in FIG. 3H, which corresponds to a beginning-of-cycle condition also illustrated in FIG. 3A.

The wafer exchange operation described above may require approximately 4.5 seconds, which is much faster than conventional wafer exchange processes which use a single-blade robot arm. Thus, throughput for the manufacturing process can be improved. Furthermore, the slit valve is maintained in an open position only for a short time, thereby minimizing the possibility of contamination. Also, the stacked-blade robot arm is simple in design and can be manufactured at reasonable cost. It is also advantageous that the exchange of wafers requires only a single insertion and retraction of the robot arm relative to the processing chamber. Thus the demands on the time of the wafer handler are minimized, freeing the wafer handler to serve other chambers.

In the example given herein, the new (unprocessed) wafer is carried into the processing chamber on the upper wafer handling blade, and the processed wafer is then carried out of the processing chamber on the lower wafer handling blade. However, this procedure may be reversed, and the lower blade may be used to carry in the wafer to be processed, and the upper blade used to withdraw the processed wafer from the processing chamber. To briefly indicate how this may be done, reference is made to FIG. 3E.

Let it be assumed that the wafer W2 shown in FIG. 3E is the processed wafer, that has been raised from the platform 12 by the storage pins 16. Wafer W1 is now assumed to be the wafer to be processed, and is brought into the processing chamber on the lower wafer handling blade 46. From the condition indicated in FIG. 3E, the storage pins 16 are retracted to place the wafer W2 on the upper wafer handling blade 44, and at the same time the lift pins 14 are extended to lift the wafer W1 from the lower wafer handling blade 46, to produce the situation indicated in FIG. 3D. Then the robot arm is retracted to remove the wafer W2, the storage pins 16 are pivoted outwardly and retracted, and the lift pins 14 are retracted to place the wafer W1 on the platform 12.

The foregoing description discloses only the preferred embodiments of the invention; modifications of the above disclosed apparatus and method which fall within the scope of the invention will be readily apparent to those of ordinary skill in the art. For example, in the embodiments of the invention illustrated above, a robot arm that includes two fixedly mounted stacked blades is used. As an alternative, a wafer handler may be used that includes two independently movable robot arms, each having a respective blade, and the two arms may be inserted simultaneously into the processing chamber. Further, rather than employing storage pins that retract to and extend from the platform 12, the storage pins may remain at a fixed elevation, and the wafer handler blade can lift and lower to transfer a wafer to or from the storage pins. In such an embodiment the lift mechanism (e.g., the lift pins 14) may lift a wafer from the storage pins and then lower the wafer to the platform.

It is also contemplated to substitute another type of lift mechanism for the lift pins 14. One possible other type of lift mechanism is the vertically movable carousel disclosed in commonly-assigned U.S. Pat. No. 5,951,770, the entire disclosure of which is incorporated herein by this reference. Other alternative lift mechanisms include conventional lift hoops, etc. Further, the sequence of operation described herein is merely exemplary. Other sequences will be readily apparent. For instance, the lift pins 14 may raise first, followed by simultaneous raising and outward pivoting of the storage pins 16; or the storage pins can raise to a level just below the wafer W1, then pivot outward, raise the wafer supporting surface of the storage pins above the wafer W1, and then pivot inward while continuing to raise.

Accordingly, while the present invention has been disclosed in connection with the preferred embodiments thereof, it should be understood that other embodiments may fall within the spirit and scope of the invention, as defined by the following claims.

The invention claimed is:

1. A wafer transfer apparatus, comprising:
a platform to and from which a wafer is to be transferred;
a first mechanism adapted to selectively define a first wafer transfer position above the platform;
a first plurality of pins selectively extendable from platform and adapted to selectively define a second wafer transfer position above the first wafer transfer position; and
a pair of transfer blades movable in unison with each other relative to the wafer transfer positions and adapted to substantially simultaneously receive a first wafer from the first wafer transfer position and deliver a second wafer at the second wafer transfer position.

2. The wafer transfer apparatus of claim 1, wherein the first mechanism includes a second plurality of pins selectively extendable through the platform.

3. The wafer transfer apparatus of claim 1, wherein the transfer blades are fixedly mounted to a robot arm.

4. The wafer transfer apparatus of claim 1, wherein each pin has associated therewith a respective pivot mechanism adapted to pivot the respective pin between a vertical position and a position that diverges from vertical.

5. The wafer transfer apparatus of claim 1, wherein each pin has a wafer support portion that extends horizontally and inwardly from an upper end of the respective pin.

6. A wafer transfer apparatus, comprising:
a platform to and from which a wafer is to be transferred;
a first mechanism adapted to selectively define a first wafer transfer position above the platform;
a first plurality of pins selectively extendable from platform and adapted to selectively define a second wafer transfer position above the first wafer transfer position; and
a pair of transfer blades movable in unison with each other relative to the wafer transfer positions and adapted to substantially simultaneously deliver a first wafer at the first wafer transfer position and receive a second wafer at the second wafer transfer position.

7. A method of transferring wafers to and from a platform, the method comprising:
lifting a first wafer from the platform;
extending a first plurality of pins from the platform; and
lowering the first wafer onto a first wafer handler blade while substantially simultaneously raising the first plurality of pins to remove a second wafer from a second wafer handler blade.

8. The method of claim 7, wherein the first wafer handler blade is below the second wafer handler blade.

9. The method of claim 7, wherein the first wafer handler blade is above the second wafer handler blade.

10. The method of claim 7, wherein the lifting step includes raising a second plurality of pins that support the first wafer.

11. The method of claim 7, further comprising pivoting the pins.

12. The method of claim 7, further comprising using the pins to lower the second wafer to the platform.

13. A method of exchanging wafers relative to a processing chamber, the method comprising:
using a first plurality of pins to place a first wafer on a first wafer handler blade; and
using a second plurality of pins to lift a second wafer from a second wafer handler blade.

14. The method of claim 13, wherein the two steps of claim 13 are performed substantially simultaneously.

15. A method of transferring wafers to and from a platform, the method comprising:
(a) raising a lifting mechanism to lift a first wafer from the platform;
(b) raising a plurality of pins;
(c) using the lifting mechanism to place the first wafer on a first wafer handler blade;
(d) using the plurality of pins to lift a second wafer from a second wafer handler blade;
(e) lowering the lifting mechanism; and
(f) using the plurality of pins to lower the second wafer to the platform.

16. The method of claim 15, wherein steps (c) and (d) are performed substantially simultaneously.

17. The method of claim 15, wherein steps (a) and (b) are performed substantially simultaneously.

18. The method of claim 15, further comprising pivoting the plurality of pins outwardly prior to step (b).

19. A method of transferring wafers to and from a platform, the method comprising:
(a) raising a lifting mechanism from a platform so as to lift a first wafer from the platform;
(b) forming a storage location, above the raised lifting mechanism, via a plurality of storage pins that have an inwardly extending wafer supporting portion;
(c) transferring the first wafer from the lifting mechanism to a first robot blade;
(d) substantially simultaneously with transferring the first wafer, transferring a second wafer from a second robot blade to the location formed by the plurality of storage pins; and
(e) lowering the second wafer to the platform.

20. The method of claim 19 wherein forming a storage location comprises pivoting the storage pins inwardly so that the wafer supporting portions thereof are able to support a wafer.

21. The method of claim 20 wherein lowering the second wafer comprises transferring the second wafer to the lifting mechanism; pivoting the storage pins outwardly so that the second wafer may lower therepast; and lowering the lifting mechanism to the platform.

22. The method of claim 20 wherein forming the storage location further comprises elevating the storage pins from the platform; and wherein lowering the second wafer comprises lowering the storage pins.
